(19) United States
(12) Patent Application Publication
(10) Pub. No.: US 2009/0138274 A1
(43) Pub. Date: May 28, 2009

(54) Adaptor for Soft Earning Unit

(76) Inventor: Samir Srivastava, Fremont, CA (US)

Correspondence Address: Samir Srivastava, 330 Tuolumne Dr, Fremont, CA, 94539, US

(21) Appl. No.: 12/137,528

(22) Filed: Jun. 11, 2008

Related U.S. Application Data
(60) Provisional application No. 60/943,071, filed on Jun. 11, 2007.
(60) Provisional application No. 60/979,730, filed on Oct. 12, 2007.
(60) Provisional application No. 60/987,016, filed on Nov. 9, 2007.

(51) Int. Cl. G06Q 30/00

(52) U.S. Cl. 705/1

(57) ABSTRACT

Current systems and business processes transactions deal in hard currencies. In the complete digital world, the common denominator further referred as Soft Earning Unit(s) with acronym SEU to value the products and services will be dealt only in computing devices. The invention pertains to adopt the existing application (s) including but not limited to computing application for dealing in SEU. The invention includes system and method for adapter module which takes the stimulus containing SEU and translates it to the form understandable by the existing application(s). The invention includes the claim for adapting the check mode of payment to the SEU environment.

This application claims the benefit of priority to U.S. Provisional Patent Application No 60/943071 filed Jun. 11, 2007, the contents of which is herby incorporated herein by reference.

This application also claims the benefit of priority to U.S. Provisional Patent Application No 60/979730 filed Oct. 12, 2007, the contents of which is herby the content of which is herby incorporated herein by reference.

This application also claims the benefit of priority to U.S. Provisional Patent Application No 60/987016 filed Nov. 9, 2007, the contents of which is herby the content of which is herby incorporated herein by reference.

### FIELD

The present invention relates to Business Process, Soft Earning Unit(s) referred with acronym SEU further, hard currencies, communication networks, computing devices, applications and adapter module for SEU in the context existing application(s).

### BACKGROUND

Money can be defined as a medium of exchange and a currency can be defined as unit of exchange. Hard currency example include US dollar, the British pound etc. Currencies exist in physical tokens in the form of coins and paper.

As the existing application(s) use databases a lot, therefore the role of database is defined here for the clarity purpose with respect to application(s) in Appendix A.

Stimulus containing hard currency is given to application(s) using different means. This application claims the adapting the check mode of hard currency to SEU environment. Check mode of payment for hard currency is described in Appendix B.

### SUMMARY

Current systems and business processes/transactions deal in hard currencies. In the complete digital world, the common denominator further referred as Soft Earning Unit(s) with acronym SEU to value the products and services will be dealt only in computing devices. The invention pertains to adopt the existing application (s) including but not limited to computing application for dealing in SEU. The invention includes system and method for adapter module which takes the stimulus containing SEU and translates it to the form understandable by the existing application(s). The invention includes the claim for adapting the check mode of payment to the SEU environment.

### BRIEF DESCRIPTION OF DRAWINGS

FIG. 1) shows the logical decomposition of currency handling in the existing application(s)

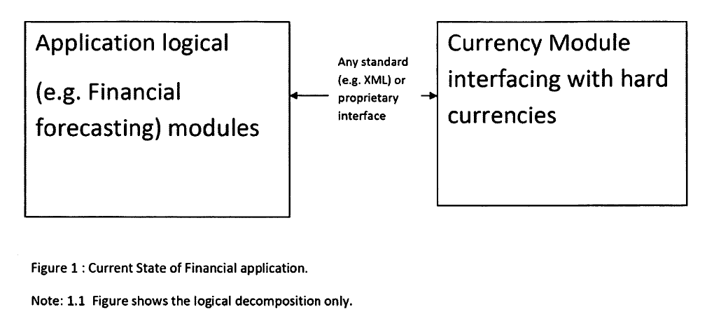

FIG. 2) shows the adaptation of application modules to SEU environment

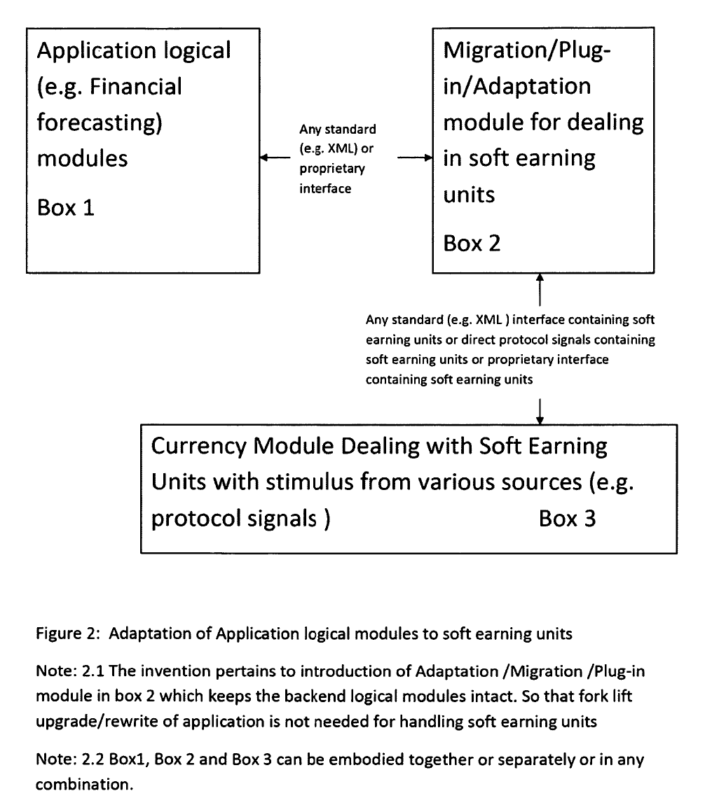

FIG. 3)shows the different entities in adapting the check process to SEU.

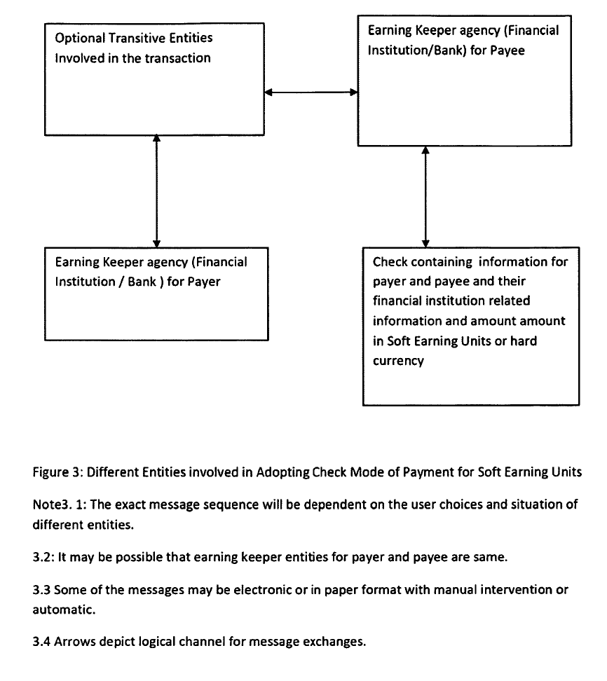

FIG. 4)shows the system overview of Adapter module

### DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

The below given specification(s) of different embodiment(s) of the invention can be implemented in any combination of hardware and software and on different networked or single computing entities. The below given specification are applicable all kinds of databases such as Oracle, Informix, SAP, DB/2 etc. They are applicable to in-memory database such as TimesTen also. Invention is not constrained by the database used.

The below given specification(s) are applicable to encrypted and/or unencrypted contents also. They are not constrained by the security policies in place in different embodiments.

In the below specification(s) and in their business process or transaction the resulting signals among the different entities involved can be exchanged using any protocol like SIP, XMPP, HTTP, SMS which will contain the soft earning units or hard currency etc info. It will be any permutation or combination of the protocols to exchange the signals. There can be altogether new protocol developed for doing this business process. Plurality of signal(s) used will contain SEU information.

In the different use cases, stimulus containing hard currencies are provided by different means such as check dealing in hard currencies, credit/debit/ATM plastic strip cards, hard currencies itself. Then this stimulus is given to the application(s) using automatic, manual or combination of both (automatic, manual) methods. Application(s) perform different tasks such as financial forecasting analysis. In some application(s), the currency is passed with normalized (converted to single currency) numerical value only and application(s) perform the analysis using them. During the presentation phase of the analysis to the user or automata or any entity, the currency code conversion is applied to the numerical value. Drawing 2 shows the logical decomposition within the context of client-server architecture of application (s). In different embodiments the currency code association is done in the client or in server module(s).

For the wire transfer messages (http://www.iso15022.org/→Index of Messages), The currency codes are passed in different messages with over the wire. The application handling the wire transfer, transfers the funds among associated account(s). Settlement of fund(s) using the wire transfer in hard currency is done automatic, manual or combination of both in different embodiments.

Some application(s) in different geographic area(s) don't deal in the different currencies. They only deal in single currency of that geographic region. In general, regulators don't allow them to deal in foreign currency.

In all of the application(s), there is plurality of signal(s) involved containing amount information in hard currency with/without currency code.

Hard Currency codes for different geographic regions are three alphabets long such as USD for United States Dollar, INR for Indian Rupee. They are defined at http://www.xe.com/iso4217.htm

Example of XML Schema for Interest Calculation

In the below application, XML schema is defined for currency code and interest calculation application using XML.

<xsd:schema xmlns:xsd = ″http://www.w3.org/2001/XMLSchema″

version = ″1.0″
elementFormDefault = ″qualified″>
<xsd:element name = ″accountSummary″>

<xsd:complexType>

<xsd:sequence>

<xsd:element ref = ″timestamp”/>
<xsd:element ref = ″currency″/>
<xsd:element ref = ″balance″/>
<xsd:element ref = ″interest″/>

</xsd:sequence>
<xsd:attribute name = ″version″ use = ″required″>

<xsd:simpleType>

<xsd:restriction base = ″xsd:string″>

<xsd:pattern value =
″[1-9]+[0-9]*\.[0-9]+″/>

</xsd:restriction>

</xsd:simpleType>

</xsd:attribute>

</xsd:complexType>

</xsd:element>
<xsd:element name = ″timestamp″ type = ″xsd:dateTime″/>
<xsd:element name = ″currency″ type = ″iso3currency″/>
<xsd:element name = ″balance″ type = ″xsd:decimal″/>
<xsd:element name = ″interest″>

<xsd:complexType>

<xsd:simpleContent>

<xsd:extension base = ″xsd:decimal″>

<xsd:attribute name = ″rounding″ use =
″required”

type = ″roundingDirection″/>

</xsd:extension>

</xsd:simpleContent>

</xsd:complexType>

</xsd:element>
<xsd:simpleType name = ″iso3currency″>

<xsd:annotation>

<xsd:documentation>ISO-4217 3-letter currency codes.
</xsd:documentation>

</xsd:annotation>
<xsd:restriction base = ″xsd:string″>

<xsd:enumeration value = ″AUD″/><!-- Australian
Dollar -->
<xsd:enumeration value = ″USD″/><!-- US Dollar -->
<xsd:length value = ″3″/>

</xsd:restriction>

</xsd:simpleType>
<xsd:simpleType name = ″roundingDirection″>

<xsd:annotation>

<xsd:documentation>Whether the interest is rounded up,
down or to the nearest round value.
</xsd:documentation>

</xsd:annotation>
<xsd:restriction base = ″xsd:string″>

<xsd:enumeration value = ″up″/>
<xsd:enumeration value = ″nearest″/>

</xsd:restriction>

</xsd:simpleType>

</xsd:schema>

Below is one instance of accountSummary

<accountSummary

version = “1.0”
xmlns:xsi = “http://www.w3.org/2001/XMLSchema-instance”
xsi:noNamespaceSchemaLocation = “accountSummary-1.0.xsd”>
<timestamp> 2008-01-01 T 12:25: 00</timestamp>
<currency>USD</currency>
<balance>2788.35</balance>
<interest rounding = “nearest”>30.55</interest>

</accountSummary>

Above XML interface is used for interfacing the logical values as an example only. Invention is not constrained by the type of interface used. It is applicable to other standards such ASN.1 or proprietary interfaces also, which deal in the SEU.

In the above example for adapting it to SEU, it will have currency Code USS for United States Soft Earning Units as an example. It can be any alphanumeric with or without special characters or any symbols to denote the Soft Earning Currency Code for a geographic region. In drawing 2, box 3 takes the input similar to above, with currency code definitions.

In drawing 2, box 2 interprets the signals as an example shown above, and does the normalization to a single currency code for the modules with other functionalities. For example, according to one embodiment of the invention it chops out the currency code USS and converts it to USD and forwards the signals using the existing infrastructure, If the existing application servers/modules need the currency code. When signal is sent back in the opposite direction, then it maps USD to USS for the currency module.

These signal(s) can be exchanged using the pipe, shared memory, semaphores, socket or any communication channels. They might use different protocols such as UDP (User Datagram Protocol), TCP (Transport Control Protocol ). SCTP (Signaling connection control protocol), TLS (Transport layer security), DTLS (Datagram TLS) as per the need of the application.

According to yet another embodiment of the invention, the interface between the Application logical modules and the currency module might be API (Application Programming Interface). Both of them are part of single executable. In this case, The code inside the API handling is changed to incorporate the mappings between USD to USS and vice versa.

According to yet another embodiment of the invention, the interface between the Application logical modules and the currency module might be archive library, shared library, Dynamic loadable Library (DLL) or any other library. In these scenarios also, the API calls will be changed for mapping to SEU code to hard currency code and vice versa.

According to yet another embodiment of the invention, the adapter module chops of the currency code and forwards amounts only, if the application modules at the backend deal only in numerals for the amount.

According to yet another embodiment of the invention, the currency code presentation on any user interfaces such as pull down menu deals in Currency codes. In this case, the adaptor module can be situated in client itself for mapping the SEU code to hard currency code and vice versa. This logic can be anywhere in client code execution path.

In another possible embodiment, the adaptor module might be situated within the server itself for mapping the SEU Code to hard currency and vice versa. This can be anywhere in server code execution path.

According to yet another embodiment of the invention, the adaptor module will be handling the transition time period from the hard currency to SEU. In one possible embodiment of the migration from hard currency to SEU, there will announced time period during which the transaction above/below certain limit will be dealt in SEU and once the system is tested, then all transaction(s) within the (sub)geographic region will be dealt in SEU only. In this case, the adaptor module will have the intelligence about the transaction limit and time period during both hard currency and SEU are acceptable.

Adaptor module will be mapping the hard currency code to SEU code mapping and vice versa based on the amount of transaction, and threshold/limit set for transaction(s) in SEU.

According to yet another embodiment of the invention, we will be extending the existing message format to include the SEU. As an example iso3currency definition will be having codes such as USS, INS.

Invention includes definition of SEU codes within/by any standard body.

According to yet another embodiment of the invention, the adaptor module just inserts the information for the hard currency within the signal. The signal(s) which arrives at the Application Module has both SEU Code and hard currency code. Application Module doesn't understand the part of the signal(s) containing the SEU Code and it ignores that, and processes the signal{s) with hard currency code. The adapter module when forwarding the signal(s) from the application side, inserts the SEU code, and the currency module processes it by ignoring the part of signal(s) containing the hard currency code.

According to yet another embodiment of the invention, the intelligence of the threshold/limit of amount of transaction for hard currency or SEU can be anywhere in the system. It can be in application module and/or adaptor module and/or currency module.

According to yet another embodiment of the invention, the multiplication factor for SEU of different geographic regions will be done in application module and/or adaptor module and/or currency module.

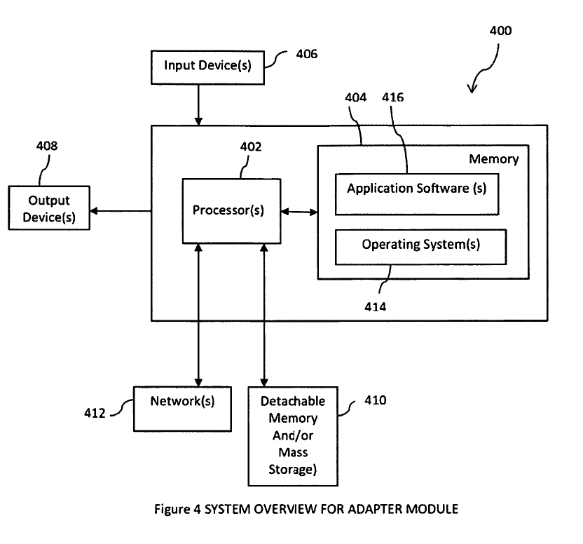

According to yet another embodiment of the invention, the adaptor module will maintain a table for mapping the part or full of plurality of signal(s) which has hard currency and/or SEU. As per FIG. 4, system view of Adapter module can be realized.

Details of Check Mode of Payment for Seu

As described in provisional application, there will be various stimulus containing SEU and check in one of them. In further section, check dealing in SEU is described. In appendix B, check mode of transaction is described. The system and method in appendix B can be adopted for dealing only in SEU. In SEU scenarios, checks can be used between payer and payee. The difference is these checks cannot be cashed, similar to account payee checks. But cash can be withdrawn from financial institution after depositing account payee checks in hard currency. This cannot be done for checks in SEU. The SEU can be debited from and credited to payer and payee accounts whether maintained at the third party institution or on device within the control of the concerned agencies e.g. payer/payee. Here SEU will be transferred between the financial institutions also based on the third party maintaining the soft earning units for the payer and payee.

The checks dealing in soft earning units can be used when a person or entity doesn't accept the signals containing soft earning units from the portable and/or unportable devices. It may be due to concerned person doesn't have the capable device or people have sentiments attached to have the same feeling as donating in hard currency (e.g. donating in hindu temples, donating to beggars). Or concerned people/parties/institutions/agencies wish due to whatever reasons to use the check mode of transaction.

The current travelers' check deals in hard currencies. These travelers' check can deal in soft earning units also. These soft earning units can be deposited/cashed at the entity where current travelers checks dealing in hard currencies are deposited/cashed. These travelers checks can be issued by the entity maintaining the soft earning units or triggered by the user wishes using his portable /un-portable device. The checks can be issued/printed by any device which is instructed to do so, based on the signals coming from the different entities. These travelers' checks can be used to convert the soft earning units of one geographic region to that of another geographic region. These travelers' check can be used to convert the soft earning units of one geographic region (such as country) to another geographic regions' (such as country) hard currency or vice versa. These travelers checks of soft earning units can be used in the same geographic region where the single soft earning unit is used with or without hard currency. As there will be transition time intervals between the soft earning unit and hard currency, so travelers' check can be used to do the conversion of soft earning units to hard currency within the single geographic region of type of currency. They can be used to convert hard currency to soft earning units also within the transition time interval.

The invention intends to adopt the current check mode of transaction / business process dealing in hard currencies to soft earning units which are maintained in computing devices in a device understandable format with any combination of hardware and/or software with/without password protection (Or any locking mechanism such as matching the finger prints, DNA etc) and/or encrypted/un-encrypted format

The above check process for soft earning units can be done completely electronically or on the wire. The check process for soft earning units can be done in paper format also or in any combination of paper or electronic format.

The above check process involves the soft earning units for the different geographic regions (Such as countries) also where they will be having different multiples to convert them between the geographic regions (such as countries) involved or they may be used to convert hard currency (such as Dollars, Euros etc) to Soft Earning Units or vice versa.

The different entities involved in check mode of payment can be identified via any mechanism such as Uniform Resource Identifier (URI), Numerical values such as cell phone number, RFID, Bar Codes, IP addresses, Chip/Smart card embedded in the entities involved. In one possible embodiment, SIP AOR (Address of Record) or URN (Uniform Resource Name) may be used to link directly to Payee/Payer information within Financial Institution. With an additional indication of linking to financial transaction, it will be directed to financial institution. In this linking/reference process different security step as stated below may or may not be applied based on different criteria's such as the usage scenario and wishes of entities involved.

Different authorization, Authentication, identity assertion, Encryption, password protection or more detailed security procedures can be applied for the checks dealing in soft earning units. Based on the scenario of the usage they can be applied in any permutation or combination or they may not be applied at all.

In the British language check is spelled as Cheque. So the above specifications are applicable to Cheque and check both. In the spirit it means a order to the bank/financial institution to pay money. Current process uses hard currencies. And the invention pertains for adopting it for Soft Earning Units.

Appendix A

Databases are commonly used for storing large quantities of similar or dissimilar data on digital systems. These databases typically follow a particular data model defined by database-specific features such as the selection of tables and table fields containing fields of the database, the data types of the various database fields, and so forth. In a key-based database system, one or more key columns are included in each table to associate the fields of a given database record across tables and table columns.

In addition to the data model, the database system architecture defines other operational characteristics of the database. For example, the database system typically will incorporate or be compatible with certain data operators that are available for combining, comparing, sorting, retrieving, or otherwise manipulating the various columns of data. Relational databases and some other databases are commonly configured to be manipulated using structured query language (SQL) queries.

Still further, the stored data itself further defines operational characteristics of the database. For example, text-based data is stored in a selected language, such as English, French, or so forth. Numeric quantities may be stored in particular units, such as monetary U.S. dollars or European euros. Time values may be specific to a particular time zone.

The effect of these various factors is to constrain a user or database application programmer to interact with the database using a rigid and inflexible format. Input data or queries are configured or structured in the language used for the textual data of the database, and receive search results or other database output in that language. If the database is in French, for example, then a user who inputs data in English or constructs queries in English will generally cause or receive adverse results. Similarly, database searching is limited to the available data operators, SQL commands, or other available search tools, and search parameters must be inputted in the language used for text entries of the database. Still further, the user dialog box displays field names and other descriptive text in the database language, making it difficult or impossible for a user unfamiliar with that language to successfully interact with the database.

An application programmer who wants to add additional functionality to the database has to write extensive code to implement the additional functionality. Moreover, this extensive code must be incorporated into each database application that accesses the additional functionality. In a typical commercial setting, the database system is provided by a first software vendor, the database is constructed in-house, and various database application programs are optionally provided by third party vendors. Each vendor develops separate and distinct programming code for extending functionality of the database in different ways, which introduces difficulties in cross-vendor software compatibility and forces the database user to deal with various different user interfaces. Moreover, there may be substantial difficulty in adapting a given commercial application program to the existing data model defined by the tables and their structure. There are application(s) with above issues are deployed and we have other application(s) which fixes the above issues with an abstraction layer. For clarification, the abstraction layer functionality is described below.

An abstraction layer for a database contains database records each including a plurality of fields stored in one or more tables, the fields being associated with the record by a key disposed in at least one key column of each of the one or more tables. The abstraction layer includes a key column identifier that identifies the at least one key column, and one or more metadata tables containing metadata relating to the database. The one or more metadata tables include at least a controls table containing control records corresponding to fields of the database. The control record for each field includes at least a control key associating the control record with the field and at least one metadatum corresponding to the field.

The invention is applicable to underlying different databases which are accessed through different metadata and/or abstraction layer.

Appendix B:

In the current financial system, checks are used between payer and payee for the cost of a service and product offered. Then checks are cashed I deposited by the payee in a financial institution. They are equivalent to currency in the sense that it triggers the transfer of the funds in hard currency (Dollars, Euros, Rupees etc) between the payer and payee accounts or cash disimbursement which may involve transaction between financial institutions (Or branches) based on payee and payer accounts or convenience of cashing/depositing.

1) Adapter module for Soft Earning Unit(s) for the existing application(s).

2) Extending the any message format such as XML, SWIFT, proprietary, standards for incorporating the Soft Earning Unit (SEU) Information.

3) Check mode of payment for dealing in Soft Earning Unit

4) Currency module for SEU

5) Adapter module in claim 1 and/or Currency module for SEU can be anywhere within execution code path of the application(s) on any computing entity.

6) Adapter module in claim 1 maps the hard currencies to SEU and vice versa.

7) Adapter module in claim 1 inserts and/or chops off hard currencies information

8) Adapter module in claim 1 inserts and/or chops off the SEU information
